(19) United States
(12) Patent Application Publication
(10) Pub. No.: US 2007/0169090 A1
(43) Pub. Date: Jul. 19, 2007

(54) Software update method and software update apparatus thereof

(75) Inventor: Su-youen Kang, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/452,277

(22) Filed: Jun. 14, 2006

(30) Foreign Application Priority Data
Dec. 12, 2005 (KR) 2005-0121638

(51) Int. Cl. G06F 9/44

(52) U.S. Cl. 717/168

(57) ABSTRACT

Disclosed are a software update method and a software update apparatus thereof. The software update method of a software update apparatus for updating a software of an electronic apparatus, includes creating and storing file information including type information of a software uploaded from the electronic apparatus; and updating the software of the electronic apparatus according to a selected version and an update command transmitted from the electronic apparatus. Accordingly, by transmitting a software update command in a user's desired version, it is possible to downgrade a version when in need and update the apparatus selectively for a single household or several households.

### CROSS-REFERENCE TO RELATED APPLICATIONS

This application claims benefit under 35 U.S.C. § 119(a) of Korean Patent Application No. 2005-121638, filed Dec. 12, 2005, in the Korean Intellectual Property Office, the entire contents of which are incorporated herein by reference.

### BACKGROUND OF THE INVENTION

1. Field of the Invention

The present invention relates to a software update method and an apparatus for updating a software. More particularly, the present invention relates to a software update method and a software update apparatus thereof, which is capable of multiversion management of software, and is capable of updating one or more electronic apparatuses in a home network environment.

2. Description of the Related Art

There is a recent trend in which an electronic apparatus is mounted with a flash memory stored with various programs enabling a high-performance operation. Such is possible because of large memory capacity and micro technology developments. The electronic apparatus stores various programs on the apparatus in the flash memory embedded therein, and the programs control overall operations or high-level operations.

The electronic apparatus additionally records new software in a memory or replaces software stored in an existing memory with changed software, to update the software for providing a new function, or changing and improving an existing service function.

FIG. 1 is a flowchart provided to explain a conventional software update method. Referring to FIG. 1, a file transfer protocol (FTP) server uploads a firmware version update file according to a selected firmware version, if a predetermined firmware version is selected (S100). The FTP server creates file information on the uploaded firmware version update file (S110), and stores the created file information (S120). The FTP server confirms a current firmware version in the file information on the firmware version update file (S130), and judges whether the current firmware version is higher than a version of a firmware apparatus (S140). When it is judged that the current firmware version is higher than the version of the firmware apparatus, the FTP server checks a component needed for updating the firmware (S150) and updates the firmware file according to the checked component (S160).

However, the conventional software update method collectively updates the software, that is, upgrades the software, when the current firmware version is higher than the version of the firmware apparatus. On the other hand, the conventional software update method does not update the software, that is, downgrades the software, when the activated firmware version is lower than the version of the firmware apparatus. Also, it is impossible to update the software of the firmware apparatus selectively for a single household or several household, because all the households are required to have their software upgraded to an activated version, at the same time. It is hard to display patch software information only through version information included in the file information.

### SUMMARY OF THE INVENTION

An aspect of the present invention is to address at least the above issues of the related art. Accordingly, an aspect of the present invention is to provide a software update method and a software update apparatus thereof, which displays software information by classifying a software package according to a characteristic.

Another aspect of the present invention is to provide a software update method and a software update apparatus thereof, which enables downgrade by adding an upgrade type.

Another aspect of the present invention is to provide a software update method and a software update apparatus thereof, which enables a multifamily version management of a software selectively for a single household or several households.

In order to achieve the above-described aspects of the present invention, there is provided a software update method of a software update apparatus for updating a software of an electronic apparatus comprising: creating and storing file information including a type information of a software uploaded from the electronic apparatus; and updating the software of the electronic apparatus according to a version selection and update commands transmitted from the electronic apparatus.

The software update method may further comprise: judging whether the update command is for upgrading or for downgrading; judging whether a version of a recent software version is higher than a version of the software, when it is decided that the update command is for upgrading; and judging whether the version of the recent software version is lower than the version of the software, when it is decided that the update command is for downgrading.

The type information of the software may be obtained by classifying the software according to characteristics of the software, and information classifying the software into at least one of a driver and operation system software, a common software for the electronic apparatus, and an image and sound volume software.

The version information of the software may comprise a name of the software, a type of the electronic apparatus, a type of the software and a version of the software.

In order to achieve the above-described aspects of the present invention, there is provided a software update apparatus updating a software of an electronic apparatus comprising: a flash memory storing a file information including a type information of a software uploaded from the electronic apparatus; and a controller creating the file information and storing the created file information in the flash memory, and updating the software of the electronic apparatus according to a selection version and an update commands transmitted from the electronic apparatus.

The controller may judge whether the update command is for upgrading or for downgrading, judge whether a version of a recent software version is higher than a version of the software, when it is decided that the update command is for upgrading, and judge whether the version of the recent software version is lower than the version of the software, when it is decided that the update command is for downgrading.

The type information of the software maybe obtained by classifying the software according to characteristics of the software, and an information classifying the software into at least one of a driver and operation system software, a common software for the electronic apparatus, and an image and sound volume software.

The version information of the software may comprise a name of the software, a type of the electronic apparatus, a type of the software and a version of the software.

The software update apparatus and the electronic apparatus can constitute a home network.

### BRIEF DESCRIPTION OF THE FIGURES

The above aspects and other features of the present invention will become more apparent by describing in detail exemplary embodiments thereof with reference to the attached drawing figures, wherein;

FIG. 1 is a flowchart provided to explain a conventional software update method;

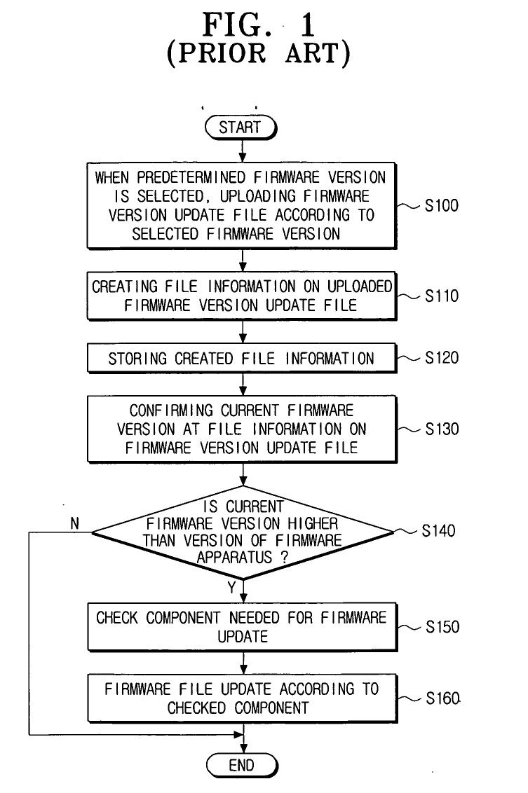

FIG. 2 is a schematic system view for updating a software of an electronic apparatus according to an exemplary embodiment of the present invention; and

FIG. 3 is a flowchart provided to explain a software update method of a software update apparatus according to an exemplary embodiment of the present invention.

### DETAILED DESCRIPTION OF EXEMPLARY EMBODIMENTS OF THE PRESENT INVENTION

Hereinafter, an exemplary embodiment of the present invention will be described in detail with reference to the accompanying drawing figures.

In the following description, the same drawing reference numerals are used for the same elements even in different drawings. The matters defined in the description such as detailed construction and elements are merely provided to assist in a comprehensive understanding of exemplary embodiments of the invention. Thus, it is apparent that the present invention can be carried out without those defined matters. Also, well-known functions or constructions are not described in detail since they would obscure the invention in unnecessary detail.

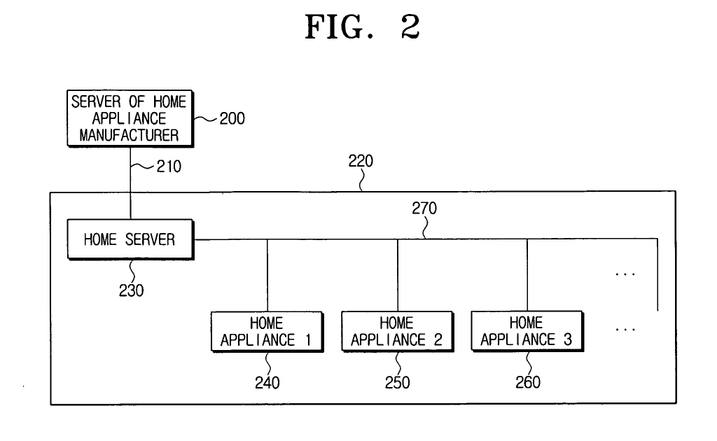

FIG. 2 is a schematic system view for updating a software of an electronic apparatus according to an exemplary embodiment of the present invention.

A recent trend is that a home network is constituted through one-network connection between a digital television, which is an example of an electronic apparatus, and home appliances such as an Internet refrigerator, a video tape recorder and a stereo. Beside the home appliances, communication media or security media are integrated, which gradually increase the number of integrative, manageable home networks in practical use. That is, the home network can be used to implement information-sharing and home automation, through a network at home.

A home server provided in the home network classifies software of home appliances according to characteristics for management, and receives an update command from a user (an administrator), to update the software of the home appliances.

Referring to FIG. 2, a server 200 of a home appliance manufacturer and a home server 230 are connected in an Internet line 210 and data is possibly transmitted. A home network 220 is constituted by connecting the home server 230 and home appliances 240, 250 and 260 at home, in local area network (LAN) 270, to enable data transmission. The home appliance manufacturer uses a file transfer protocol (FTP), to achieve data communication between the server 200 of a home appliance manufacturer, the home server 230, and the home appliances 240, 250 and 260.

The server 200 of a home appliance manufacturer communicates with the home server 230 of each home using the Internet line 210, and provides the software of each of the home appliances 240, 250 and 260.

The home server 230 is provided with the software of each of the home appliances 240, 250 and 260 from the server 200 of a home appliance manufacturer. The home server 230 communicates with each of the home appliances 240, 250 and 260 connected thereto in the LAN 270, to confirm a version of a software currently mounted in the each of the home appliances 240, 250 and 260, and update to a new software. The home server 230 may be separately provided, or an always power-on refrigerator and a digital television may be used. Accordingly, the home server 230 includes a flash memory (not shown) and a controller (not shown) as other home appliances do.

Each of the home appliances 240, 250 and 260 are downloaded with the software provided from the home server 230 in the flash memory, and the software is updated.

The LAN 270 is a means to connect the home server 230 and the home appliances 240, 250 and 260, which constitute the home network 220. Wire and wireless next-generation interfaces such as a power line communication (PLC), IEEE1394, and a home radio frequency (RF), may replace the LAN 270.

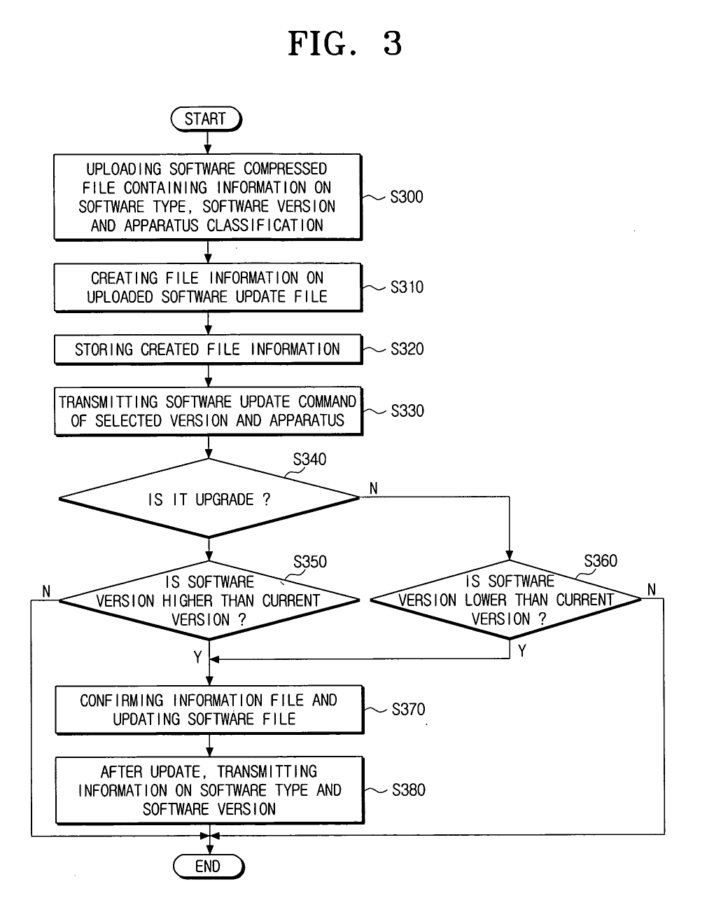

FIG. 3 is a flowchart provided to explain a software update method of a software update apparatus according to an exemplary embodiment of the present invention.

Referring to FIG. 3, each of the home appliances 240, 250 and 260 uploads to a home server 230 a software compressed file containing information on a type, a version and an apparatus classification of a software (S300). The home server 230 periodically communicates with power-on home appliances 240, 250 and 260, to receive the information on a type, a version and an apparatus classification of a software of each of the home appliances 240, 250 and 260. The home server 230 periodically communicates with a server 200 of a home appliance manufacturer by use of an Internet line 210, and has recent software of each home appliance 240, 250 and 260 and version information of the recent software, and version information of a current software of each of the home appliances 240, 250 and 260.

The home server 230 creates file information on an uploaded software update file (S310), and stores the created file information in a flash memory embedded in the home server 230 (S320). Table 1 is the file information on the software update file created by the home server 230.

TABLE 1

| Package | Package | |
|---|---|---|
| classification | characteristic | Version |
| Platform | Software on | NAME_DEVICEtype_PLATFORM_Vo.1 |
| | device driver | |
| | and | |
| | operation | |
| | system | |
| Common | Common | NAME_DEVICEtype_COMMON_Vo.1 |
| | software for | |
| | apparatus | |
| Site-specific | Software on | NAME_DEVICEtype_SITE_Vo.1 |
| | image and | |
| | sound | |
| | volume | |

As illustrated in table 1, file information contains software classification information according to a software package characteristic and version information. The home server 230 classifies the software package characteristic into a software on a device driver and operation system, a common software for an apparatus and a software on image and sound volume. The home server 230 is classified into a platform type, a common type and a site-specific type, according to the classified software package characteristic. The home server 230 creates the version information including software type information corresponding to each classified type, that is, a software name, a software apparatus classification, a software type and a software version.

Home appliances 240, 250 and 260 transmit to the home server 230 a software update command of a version and apparatus selected by the user (the administrator) (S330). The update command includes an upgrade command for raising a software version and a downgrade command for lowering a software version.

When the update command is transmitted, the home server 230 judges whether the transmitted update command is for upgrading or not (S340). The transmitted command is judged based on the update command or the selected version. More particularly, when the selected version is higher than a current software version, it is judged to be the upgrade command, and when the selected version is lower than the current software version, it is judged to be the downgrade command.

When the transmitted update command is judged to be for upgrading (S340-Y), the home server 230 judges whether a software version is higher than the current version (S350). More particularly, the home server 230 compares the version information of a recent software transmitted from a server 200 of a home appliance manufacturer and the current software version information.

When the transmitted update command is judged not to be for upgrading, that is, to be for downgrading (S340-N), the home server 230 judges whether the software version is lower than the current version (S360).

When the software version is judged to be higher than the current version in case of the upgrade command, or when the software version is judged to be lower than the current version in case of the downgrade command, the home server 230 confirms the information file and updates the software file to a corresponding home appliance (S370).

After update, the home appliances 240, 250 and 260 transmit the software type information and version information to the home server 230 (S380).

As mentioned above, according to an exemplary embodiment of the present invention, by transmitting an update command of a software in a desired version, it is possible to downgrade a software when in need and update an apparatus selectively for a single household or several households. Also, version information is enabled according to a software type after a software upgrade.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A software update method of a software update apparatus which updates a software of an electronic apparatus, the software update method of the software update apparatus comprising:
creating file information including a type information of a software uploaded from the electronic apparatus; and
updating the software of the electronic apparatus according to a version selection and at least one update command transmitted from the electronic apparatus.

2. The software update method according to claim 1, wherein said file information is stored.

3. The software update method of claim 1, further comprising:
judging whether at least one update command is for upgrading or for downgrading;
judging whether a version of a recent software version is higher than a version of the software, if it is determined that the update command is for upgrading; and
judging whether the version of the recent software version is lower than the version of the software, if it is determined that the update command is for downgrading.

4. The software update method of claim 1, wherein the type information of the software is obtained by classifying the software according to characteristics of the software, the software being classified as at least one of a driver and operation system software, a common software for the electronic apparatus, and an image and sound volume software.

5. The software update method of claim 1, wherein the version information of the software comprises at least one of a name of the software, a type of the electronic apparatus, a type of the software and a version of the software.

6. A software update apparatus which updates a software of an electronic apparatus using a software update method, the software update apparatus comprising:
a flash memory which stores file information including type information of a software uploaded from the electronic apparatus; and
a controller which creates the file information and stores the created file information in the flash memory, and updates the software of the electronic apparatus according to a selected version and at least one update command transmitted from the electronic apparatus.

7. The software update apparatus of claim 6, wherein the controller judges whether the at least one update command is for upgrading or for downgrading, judges whether a version of a recent software version is higher than a version of the software, if it is determined that the at least one update command is for relates to upgrading, and judges whether the version of the recent software version is lower than the version of the software, if it is determined that the at least one update command relates to downgrading.

8. The software update apparatus of claim 6, wherein the type information of the software is obtained by classifying the software according to characteristics of the software, the software being classified as at least one of a driver and operation system software, a common software for the electronic apparatus, and an image and sound volume software.

9. The software update apparatus of claim 6, wherein version information of the software comprises at least one of a name of the software, a type of the electronic apparatus, a type of the software and a version of the software.

10. The software update apparatus of claim 6, wherein the software update apparatus and the electronic apparatus constitute a home network.
